(19) United States
(12) Patent Application Publication
(10) Pub. No.: US 2014/0223910 A1
(43) Pub. Date: Aug. 14, 2014

(54) ENERGY-STORING DEVICE AND METHOD FOR STORING ENERGY

(71) Applicants: Christian Brunhuber, Auerbach (DE); Carsten Graeber, Erlangen (DE); Gerhard Zimmermann, Hochstadt/Aisch (DE)

(72) Inventors: Christian Brunhuber, Auerbach (DE); Carsten Graeber, Erlangen (DE); Gerhard Zimmermann, Hochstadt/Aisch (DE)

(73) Assignee: SIEMENS AKTIENGESELLSCHAFT, Munich (DE)

(21) Appl. No.: 14/346,728

(22) PCT Filed: Sep. 5, 2012
(86) PCT No.: PCT/EP2012/067297

§ 371 Date: Apr. 28, 2014

(30) Foreign Application Priority Data
Sep. 29, 2011 (EP) 11183274.7

(51) Int. Cl. F01K 23/02; F15B 11/06

(52) U.S. Cl. CPC F01K 23/02; F15B 11/06
USPC 60/659; 60/412; 60/408; 60/327

(57) ABSTRACT

An energy-storing device with a charging circuit for a working gas for storing thermal energy, comprising a compressor, a heat accumulator, and an expansion turbine is provided. The compressor is connected to the inlet of the expansion turbine at the outlet side of the compressor via a first line for the working gas, and the heat accumulator is connected into the first line. The compressor and the expansion turbine are arranged on a common shaft, and the heat exchanger of the heat accumulator is designed such that the working gas which is expanded in the expansion turbine largely matches the thermodynamic state variables of the working gas prior to entering the compressor. Only a part of the thermal energy is transferred to the heat accumulator in the process. The working gas fed to the expansion turbine remains relatively hot.

### CROSS REFERENCE TO RELATED APPLICATIONS

This application is the U.S. National Stage of International Application No. PCT/EP2012/067297 filed Sep 5, 2012, and claims the benefit thereof. The International Application claims the benefit of European Application No. EP11183274 filed Sep 29, 2011. All of the applications are incorporated by reference herein in their entirety.

### FIELD OF INVENTION

The need for the storage of energy arises particularly from the constantly growing contribution made to a power plant from the sector of renewable energies. The aim of energy storage is in this case to make it possible to utilize power plants with renewable energies in the electricity transmission networks in such a way that access to renewably generated energy can be afforded even when there is time lag, in order thereby to avoid fossil energy carriers and therefore CO₂ emissions.

### BACKGROUND OF INVENTION

US 2010/0257862 A1 describes a principle of a known energy storage device in which a piston engine is employed. Moreover, according to U.S. Pat. No. 5,436,508, it is known that, by means of energy storage devices for storing thermal energy, overcapacities in the utilization of wind energy for generating electrical current can also be intermediately stored.

JP 2008 180449 A describes a cooling device with a thermal water store, which cooling device guides air between a compressor open to the surroundings and an expansion turbine. The heat occurring during compression is discharged from the system by means of a heat exchanger and delivered to the water store for later utilization. In this case, a heat quantity not controlled any further is extracted from the air. As a result of the expansion of the air in the expansion turbine, the temperature level of the air falls to temperatures down to −80° C. The cold released in this case is subsequently made available to a cooling process in a cooling device open to the surroundings.

Energy stores of this type convert electrical energy into thermal energy during the charging of the store and store the thermal energy. Upon discharge, the thermal energy is for instance converted into electrical energy again.

On account of the time span which an energy store has to bridge, that is to say the time during which energy is fed into or out of the energy store, and because of the power which is to be stored, the dimensions of thermal energy stores have to satisfy correspondingly high requirements. If only because of the construction size thermal energy stores may therefore be very costly to procure. If the energy store has a complicated configuration or the actual heat storage medium is costly to procure or is complicated to operate, the procurement and operating costs for a thermal energy store can quickly cast doubts upon the viability of energy storage.

So that the production costs of the energy store can be balanced, cost-effective storage material, in particular porous materials, but also sand, gravel, rock, concrete, water, salt solution, etc., is preferred. The heat exchanger should also have as cost-effective a dimensioning as possible. However, because of the often low thermal conductivity of the cost-effective storage materials, the heat exchanger surfaces often have to be designed to be very large. The large number and length of the heat exchanger tubes can in this case sharply increase the costs of the heat exchanger which can no longer be compensated even by a cost-effective storage material.

Heat exchangers based on cost-effective materials have hitherto been configured mainly in the form of direct exchange of the heat transfer medium, such as, for example, air, and of the storage material, such as, for example, sand or rock, so as to replace large heat exchangers. The fluidized bed technology known in principle in the art has hitherto not been adopted on a scale which would be necessary for seasonal storage of renewable excess energy. Moreover, direct heat exchange entails relatively complicated handling of the solid, and this is not economical for a large-scale store.

The heat transfer medium used is a working gas, such as, for example, air. The working gas may in this case be routed selectively in a closed or an open charging circuit or additional circuit.

An open circuit always employs ambient air as working gas. This is sucked in from the surroundings and also discharged into these again at the end of the process, so that the surroundings close the open circuit. A closed circuit also enables a working gas other than ambient air to be used. This working gas is routed in the closed circuit.

Since expansion into the soundings, at the same time with the setting of ambient pressure and ambient temperature, is dispensed with, in a closed circuit the working gas has to be routed through a heat exchanger which enables heat from the working gas to be emitted into the surroundings. Since, in a closed circuit, dehumidified air or other working gas can also be used, there is no need for a multistage configuration of the compressor or for a water separator. The disadvantage here, however, is the additional cost outlay for the procurement and operation of an additional heat exchanger downstream of the expansion turbine or upstream of the compressor, in order to heat the working gas to the working temperature for the compressor. The operating efficiency of the energy storage device is consequently diminished.

Alternatively, there may be provision whereby the charging circuit for storing the thermal energy in the heat store is designed as an open circuit, and the compressor is composed of two stages, a water separator for the working gas being provided between the stages. This allows for the fact that ambient air contains atmospheric moisture. Expansion of the working gas in a single stage may cause the atmospheric moisture to condense on account of the sharp cooling of the working gas to, for example −100° C. and at the same time to damage the expansion turbine. In particular, turbine blades may be permanently damaged due to icing-up. However, expansion of the working gas in two steps makes it possible to separate condensed water in a water separator downstream of the first stage, for example, at 5° C. so that, during further cooling of the working gas in the second turbine stage, this condensed water is already dehumidified and the formation of ice can be prevented or at least reduced. Here too, however, there is the disadvantage of an increased cost outlay for the procurement of a multistage compressor and a water separator. The operating efficiency of a plant of this type is also diminished.

### SUMMARY OF INVENTION

An object of the invention is to specify a cost-effective energy storage device for storing thermal energy, based on cost-effective storage materials, which has improved efficiency. At the same time, in particular, the disadvantages of the prior art are to be avoided. A further object of the invention is to specify a method, in which thermal energy can be stored in cost-effective storage materials with improved efficiency.

That object of the invention which is directed at a device is achieved by the features of the independent claims. Accordingly, an energy storage device for storing thermal energy, with a charging circuit for a working gas, comprises a compressor, a heat store and an expansion turbine, the compressor being connected on the outlet side to the inlet of the expansion turbine via a first line for the working gas, and the heat store being inserted into the first line. According to aspects of the invention, then, the compressor and the expansion turbine are arranged on a common shaft, and the heat exchanger of the heat store is designed in such a way that the working gas expanded in the expansion turbine corresponds largely to the thermodynamic state variables of the working gas for entry into the compressor. Thermodynamic state variables are understood in this context to mean, in particular, the pressure and temperature of the working gas.

The invention in this case proceeds from the notion that the working gas emits only part of its heat in the heat exchanger of the heat store, and therefore the working gas, upon entry into the expansion turbine, is still relatively hot. This affords the situation where the temperature of the expanded working gas may fall very low as a result of expansion in the expansion turbine. The working gas is therefore not cooled completely in the heat store. This consequently means that the heat store has to absorb only part of the available thermal energy, to be precise, in particular, the high temperatures.

Aspects of the invention, then, make use of the fact that, although only part of the available thermal energy is stored, the overall balance of energy storage is shifted in favor of increased efficiency. This is explained, on the one hand, by the fact that a device for warming, intermediately heating or dewatering the expansion air, which otherwise has an adverse effect upon efficiency, may be dispensed with. By expansion to ambient pressure and ambient temperature, the problem of the condensation of water is thus advantageously avoided, even when moist intake air is used for the compressor. Thus, in the method according to aspects of the invention, no damage due to frozen condensate can occur. A condenser may also be dispensed with.

Moreover, the expansion turbine reduces the energy outlay for compression in that it is arranged on the same shaft as the compressor and essentially also assists the compressor.

Since the cooling of the working gas requires very large heat exchanger surfaces at low temperatures, avoiding the need to utilize the lower temperatures also has a beneficial effect upon the heat store, since the heat exchanger can have smaller dimensioning.

Overall, by virtue of the measure according to aspects of the invention, a considerable increase in the efficiency of energy storage is achieved. Moreover, the energy storage device according to aspects of the invention is substantially more beneficial in terms of procurement than a conventional energy storage device in which the working gas is cooled essentially completely in the heat exchanger.

In an advantageous further development of the invention, a second line for the working gas is provided, via which the outlet of the expansion turbine and the inlet of the compressor are connected to one another. By the working gas which expanded in the expansion turbine being recirculated back into the compressor, a closed circuit is thus formed for the working gas. A closed circuit of the working medium additionally makes it possible to have a more cost-effective design, for example due to the use of an inert gas with higher thermal conductivity (such as, for example, helium) or due to the avoidance of condensation (for example, by using dry air). If, then, according to aspects of the invention, the working gas is not cooled completely in the heat exchanger, after expansion in the expansion turbine it is approximately at the thermodynamic level of the working gas at the inlet of the compressor. An additional heat exchanger which would otherwise have to warm the working gas for use in the compressor, can thereby be dispensed with.

The outfeed of the stored energy may take place, for example, via a steam circuit.

An object of the invention which is directed at a method is achieved by the features as claimed herein. A method for storing thermal energy by a charging operation is claimed. In the charging operation, in a compressor process a working gas with a temperature T1 and with a pressure P1 is compressed to a pressure P2 and a temperature T2. In a heat exchanger process following the compressor process, heat is transmitted to a heat store, with the result that the temperature and pressure of the working gas are reduced to a temperature T3 and a pressure P3. In an expansion process following the heat exchanger process, the working gas is expanded to a pressure P4 and a temperature T4, the temperature T3 and pressure P3 being set such that the temperature T4 and pressure P4 after the expansion process correspond largely to the temperature T1 and the pressure P1 before the compressor process.

It is thus possible that the working gas can be recirculated to the compressor process after the expansion process. A circuit is formed by recirculation. Inert gas can be used in the circuit. The temperature T3 and pressure P3 are in this case set preferably by the dimensioning of the heat exchanger process and in this case, in particular, by the size of the heat exchanger surface. Since the working gas has to emit only part of its heat energy to the heat store via the heat exchanger, the size of the heat exchanger surface can be substantially reduced. Considerable costs for procuring the heat store can thereby be saved.

Preferably, the expansion energy released in the expansion process is transmitted to the compressor process. The energy which has not been transmitted in the form of heat to the heat store therefore also makes an appreciable contribution to the compression of the working gas.

The thermal energy may be seasonally occurring excess energy of a power plant using renewable energies. Suitable storage material for the heat store of the heat exchanger process is, especially, porous materials, sand, gravel, rock, concrete, water or salt solution.

### BRIEF DESCRIPTION OF THE DRAWINGS

The invention is explained in more detail below by means of figures in which:

FIG. 1 shows an energy storage device with a charging and a discharging circuit;

FIG. 2 shows a further development of the energy storage device from FIG. 1;

FIG. 3 shows a method for storing thermal energy;

FIG. 4 shows a further development of the method from FIG. 3.

### DETAILED DESCRIPTION OF INVENTION

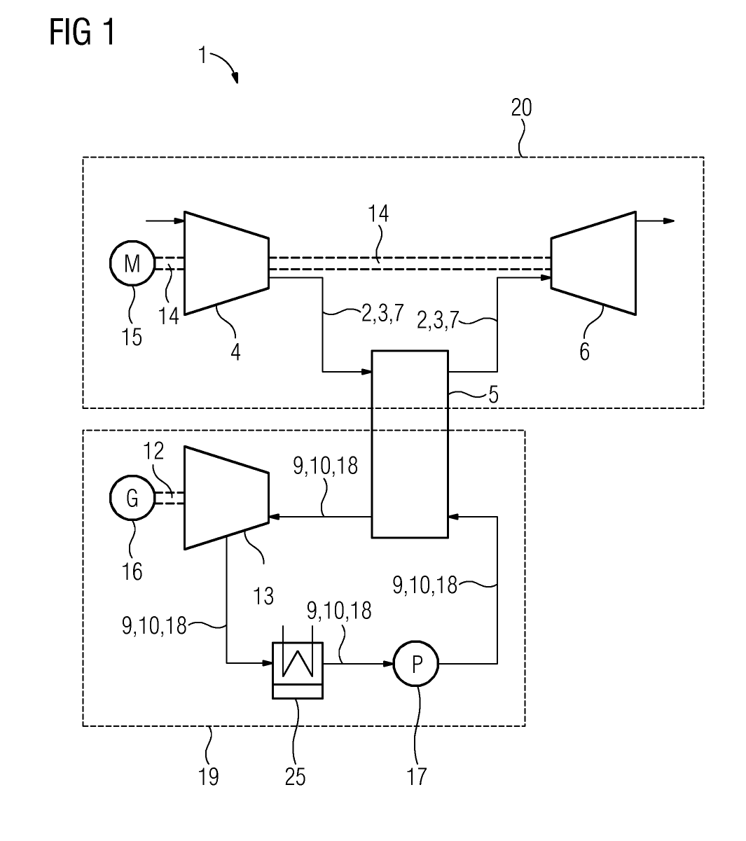

FIG. 1 shows an energy storage device 1 with a charging circuit 2 and with a discharging circuit 9. The charging circuit 2 is an integral part of the charging operation 20. The charging circuit 2 comprises essentially a first line 7 which connects a compressor 4 to a heat store 5 and to an expansion turbine 6. The compressor 4 and the expansion turbine are illustrated diagrammatically here and stand for all possible concepts such as, for example, also a multistage version with the intermediate cooling or intermediate heating.

The compressor 4 is arranged together with the expansion turbine 6 on a common shaft 14. Moreover, the shaft 14 is driven by an electric motor 15.

The heat store 5 is likewise illustrated only diagrammatically here. The heat store is composed essentially of a heat exchanger for the infeed of thermal energy, or a heat exchanger for the outfeed of thermal energy and of the actual storage material. The heat store used according to aspects of the invention contains a cost-effective storage material, such as porous materials, sand, gravel, rock, concrete, water or salt solution. Moreover, the heat store may be multi-layered, in order to form a region for the storage of high temperatures and regions for the storage of low temperatures.

The discharging circuit 9 is an integral part of the discharging operation 19. The discharging circuit 9 comprises essentially the heat store 5 which is connected via a steam line 18 for a second working gas 10 to a steam turbine 13, the steam turbine 13 being connected to a generator 16 on a common second shaft 12. The steam line 18 is in this case configured as an open circuit. In this case, steam is fed out of the steam turbine 13 as a second working gas 10 and is delivered via an optional heat exchanger 25 and a pump 17 to the heat exchanger of the heat store 5 for the outfeed of heat energy.

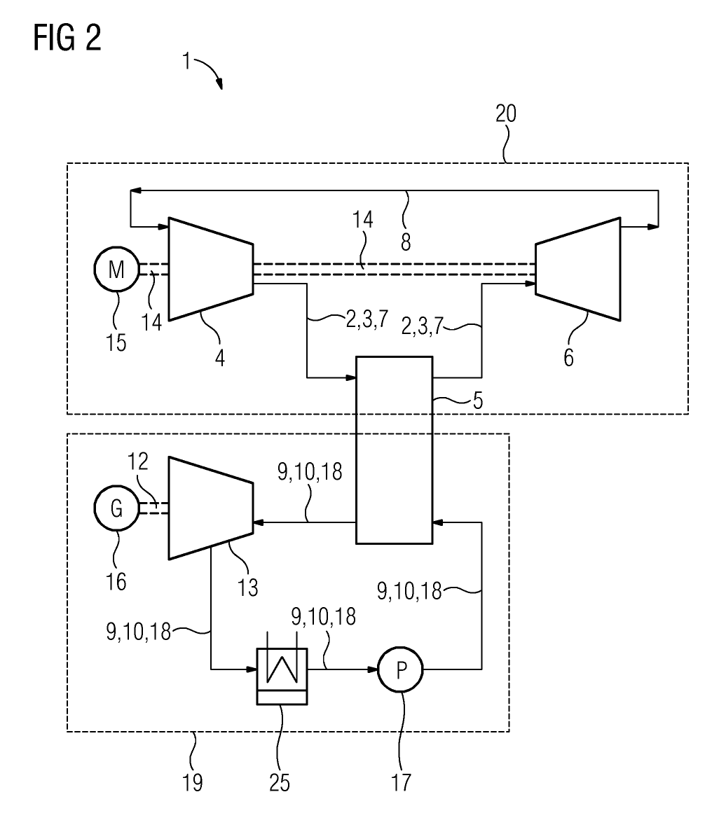

FIG. 2 shows an advantageous further development of the energy storage device according to the invention. In addition to the energy storage device shown in FIG. 1, the charging circuit 2 is in this case configured as a closed circuit. For this purpose, a second line 8 for the working gas 3 is provided, which connects the outlet of the expansion turbine and the inlet of the compressor to one another.

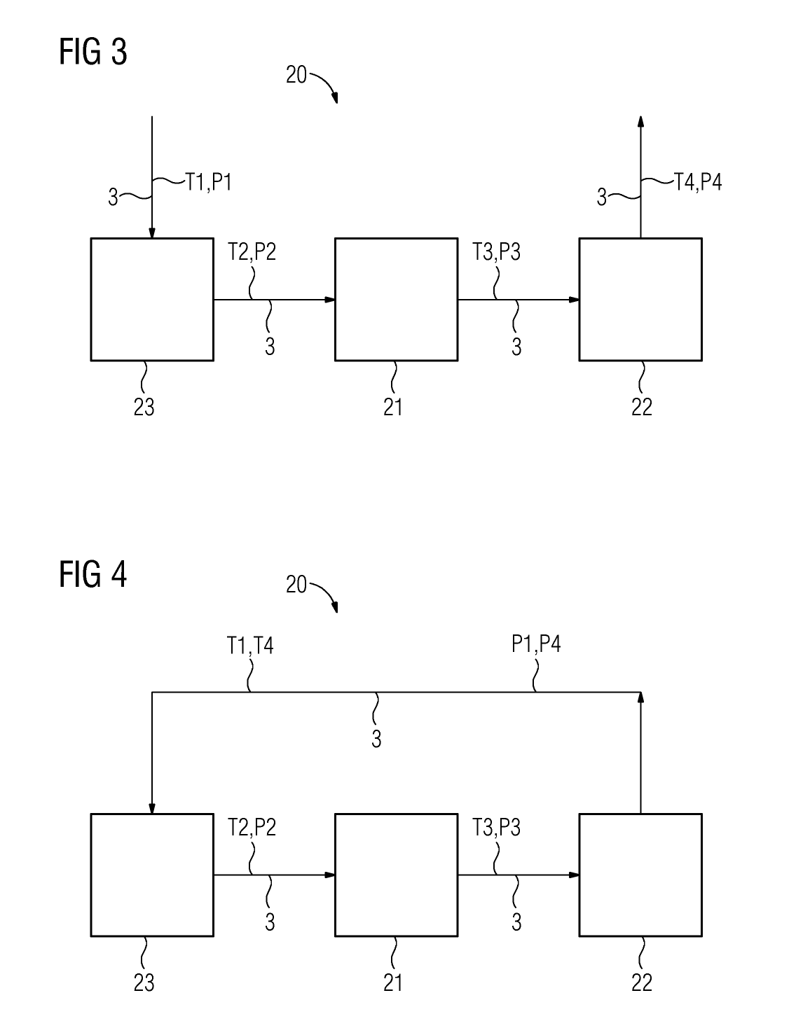

FIG. 3 shows a method for the storage of energy. The method comprises a charging operation 20 and discharging operation 19. Only the charging operation 20 is illustrated here.

The charging operation 20 comprises a compressor process 23, a heat exchanger process 21 and an expansion process 22. The charging operation is operated here as an open circuit.

A working gas 3, for example ambient air, with a temperature T1 of, for example, 20° C. and with a pressure P1 of, for example, 1 bar is delivered to the compressor process 23. The working gas 3 is compressed in the compressor process 23. The working gas 3 leaves the compressor process 23 with a temperature T2 of, for example, 550° C. and with a pressure P2, of, for example, 20 bar. The working gas 3 is delivered under these thermodynamic conditions to the heat exchanger process 21 in which, according to the invention, it emits only part of its heat and is therefore only cooled to a relatively small extent. The working gas 3 leaves the heat exchanger process 21 with a pressure P3 of, for example, 15 bar and with a still relatively high temperature T3 of, for example, 230° C. The pressure P3 can in this case advantageously be set by the dimensioning of the heat exchanger process 21.

The working gas 3 is delivered under these conditions to the expansion process 22 where it is expanded. As a result of the lowering of the pressure, the working gas 3 is cooled to a virtually ambient temperature. The working gas 3 leaves the expansion process 22 with a temperature T4 of, for example, 20° C. and with a pressure P4 of, for example, 1 bar.

The temperature T1 thus corresponds approximately to the temperature T4 and the pressure P1 approximately to the pressure P4.

FIG. 4 shows a further development of the method according to the invention. The charging operation 20 from FIG. 3 is illustrated. In addition, however, a connection returning the working gas 3 is present between the expansion process 22 and the compressor process 23. The charging circuit 2 for the working gas 3 is thereby designed as a closed circuit.

On account of the high temperature T2 after the compressor process 23, there is no risk of water condensation in the heat store process 21.

1. An energy storage device for storing thermal energy, with a charging circuit for a working gas, comprising
a compressor, a heat store and an expansion turbine, the compressor being connected on an outlet side to an inlet of the expansion turbine via a first line for the working gas, and the heat store being inserted into the first line,
wherein the compressor and the expansion turbine are arranged on a common shaft, and
wherein a heat exchanger of the heat store is designed such that the working gas, which is expanded in the expansion turbine, largely matches thermodynamic state variables of the working gas before entry into the compressor.

2. The energy storage device as claimed in claim 1, further comprising
a second line for the working gas, via which an outlet of the expansion turbine and an inlet of the compressor are connected to one another, so that a closed charging circuit is formed.

3. The energy storage device as claimed in claim 1, wherein
the heat store is inserted into a discharging circuit for a second working gas, the heat exchanger being connected to a steam turbine in the discharging circuit.

4. The energy storage device as claimed in claim 1, wherein
the energy storage device is adapted for use in a power plant, operated with renewable energies, for storage of seasonal excess electrical energy.

5. The energy storage device as claimed in claim 1, wherein
storage material of the heat store comprises porous materials, sand, gravel, rock, concrete, water or salt solution.

6. A method for storing thermal energy, comprising, in a charging process,
a) in a compressor process a working gas is compressed from a temperature T1 and a pressure P1 to a pressure P2 and a temperature T2,
b) in a heat exchanger process heat is transmitted to a heat store, with a result that the temperature and pressure of the working gas are reduced to a temperature T3 and a pressure P3, and
c) in an expansion process the working gas is expanded to a pressure P4 and a temperature T4,
wherein the temperature T3 and pressure P3 being set such that the temperature T4 and pressure P4 after the expansion process correspond largely to the temperature T1 and the pressure P1 before the compressor process.

7. The method as claimed in claim 6, wherein the temperature T3 and pressure P3 are set by a dimensioning of the heat exchanger process.

8. The method as claimed in claim 6, wherein expansion energy released in the expansion process is transmitted to the compressor process.

9. The method as claimed in claim 6, wherein the compressor is driven by seasonally occurring excess electrical energy of a power plant using renewable energies.

10. The method as claimed in claim 6, wherein storage material used for the heat store of the heat exchanger process comprises porous materials, sand, gravel, rock, concrete, water or salt solution.
